(19) United States
(12) Patent Application Publication
(10) Pub. No.: US 2007/0110047 A1
(43) Pub. Date: May 17, 2007

(54) Method of collecting and searching for access route of information resource on internet and computer readable medium stored thereon program for implementing the same

(76) Inventor: Sun-Kwon Kim, Ansan-si (KR)

Correspondence Address: IPLA P.A., 3580 WILSHIRE BLVD., 17TH FLOOR, LOS ANGELES, CA, 90010, US

(21) Appl. No.: 10/596,913

(22) PCT Filed: Jan. 31, 2005
(86) PCT No.: PCT/KR05/00281

§ 371 Date: Jun. 28, 2006

(30) Foreign Application Priority Data
Jan. 30, 2004 (KR) 10-2004-0006341

(51) Int. Cl. H04L 12/28

(52) U.S. Cl. 370/389; 370/256

(57) ABSTRACT

Disclosed is a method for systematically collecting and searching for access routes of information resources. Search index node is formed in hierarchical tree structure in the computer. Basic search information including access route and name of resource loaded on web browser is input with selection of search index node. Information node is configured and stored in linkage with the selected search index node based on the basic search information. Text search window is provided to the user to receive hierarchical information node access route distinguished by identifier, output node name list in the hierarchy corresponding to the identifier, receive user selection of node name from the list, and adds the selected node name to the identifier to hierarchically extend the access route step by step. When settled, the access route is extracted, and target information resource is obtained through Internet to be output to the user.

### TECHNICAL FIELD

The present invention relates to a technique of hierarchically collecting and managing Internet information resources and also giving a convenient searching environment for the information resources under the text-based circumstance, and more particularly to a method of providing a software environment that allows a user to search for information resources in a convenient and fast way by constructing Internet information resources, obtained by a user during web search, into a node structure with a hierarchical tree structure and using a text-based search window, and also enables a plurality of users to share the node structure through a web. The present invention also relates to a computer readable medium that stores a program for implementing the method.

### BACKGROUND ART

At present, Internet acts as a medium for sharing knowledge, and it is not too much to say that Internet itself is a favorite of knowledge. Any user who wants knowledge may access Internet at any time and then obtain target information easily by using a search engine. Now, it is more important who may find and classify information faster, rather than who knows more information.

However, the cyber space, called Internet, is not easy to systematically manage information obtained via Internet due to its huge bulk and complicated data built therein. It is because information obtainable on Internet generally has an access route expressed by complex URL, so the access route is not easily memorized. Thus, though having visited a site in old times, sometimes even though having registered the site in a bookmark of a web browser, a user is apt to fine the site again by using a search engine as he/she did once. That is to say, there always remains a problem that time is invested duplicately since the access route of the information on Internet is not systematically managed.

Though a general web browser such as Internet Explorer gives a bookmark function for managing web site information, the bookmark function has a limit in its storing capacity. In particular, the bookmark function is implemented using a graphic interface, and a user should open a category folder one by one with a mouse. Thus, if an amount of information stored in the bookmark is increased, it is not easy to find desired information even in the bookmark menu.

Meanwhile, a service for exchanging data in PtoP manner recently stands in the spotlight of Internet users. As an representative example, there is Soribada that allows MP3 files to be shared by means of PtoP manner. However, most PtoP service adopts an extremely simple search interface for the present, and its search result is also provided in a list format, so it is very inconvenient to search and specify target information.

In addition, the existing PtoP service mostly shares media files with a multimedia characteristic, but the intelligence, or an aggregate of systemized and arranged access routes for information collected on Internet, is completely excluded from a subject to be shared.

However, if a plurality of users may share systemized access routes to information, collected on Internet, via a web, it will be possible for a user to effectively obtain an intelligence within a short time by obtaining an access route of desired information with relatively less efforts and collecting information on the basis of the access route without using a search engine.

### DISCLOSURE OF INVENTION

The present invention is designed to solve the problems of the prior art, and therefore an object of the invention is to provide a program environment, which allows a user to manage access routes of various Internet information resources obtained as a result of web search in a hierarchical and systematical manner, and also enables a user to rapidly and efficiently search a previously constructed access route of information resource with the use of a text-based search window and then directly access the searched Internet information resource.

A technical object of the present invention to be achieved is to provide a data sharing method, which enables a user to rapidly obtain an access route of information that the user desires to fine on Internet by allowing the user to share access routes of Internet information resources constructed by a plurality of users through a web.

In order to accomplish the above object, the present invention provides a method for systematically collecting and searching for an access route of an information resource on Internet so that a program executed on a computer systematically collecting access routes of information resources on Internet and provides a text-based information searching environrnent, the method comprising: (a) forming a search index node in a hierarchical tree structure in a storage medium of the computer according to a request of a user; (b) receiving basic search information including an access route and a name of an Internet information resource loaded by a user using a web browser, and a selection of a search index node to be linked with the basic search information from the user, and then configuring and storing an information node in linkage with the search index node selected by the user on the basis of the basic search information; (c) providing a text search window to the user, receiving a hierarchical information node access route distinguished by a search event identifier through the search window, outputting a name list of search index nodes and/or information nodes in a hierarchy corresponding to an input order of the identifier when there is an input of the identifier, receiving a selection of the user for a node name included in the name list, and then adding the selected node name to the identifier so that the access route to the information node is hierarchically extended step by step; and (d) when an access route to a target information node is settled, extracting an access route of an Internet information resource corresponding to the corresponding information node, obtaining a target Internet information resource through Internet with the use of the extracted access route, and then outputting the target Internet information resource to the user.

In the present invention, the search index node is preferably composed of a file folder with a name designated by the user, and the information node is composed of a file capable of extracting information about a name and an access route (URL: Uniform Resource Locator) of the information resource on Internet. In addition, the information node file is preferably stored in a search index folder selected by the user. The hierarchical information node access route has a format in which at least one node name with a search event identifier as a prefix is connected in series.

In the present invention, the process of outputting the node name list according to the input of the search identifier and the process of extending the information node access route according to the selection of a name of a node included in the list are preferably repeated in a cycle until a target information node is output in the node name list.

In the present invention, when the user inputs a text syllable by syllable in the state that the node name list is output, a node selection curser is automatically moved to a node name having the input text. In addition, when the user manipulates a predetermined node name selection key prepared on a keyboard in the state that the node selection curser is moved to a predetermined node name, the node name is added to the search event identifier so as to extend the information node access route by one step.

In another aspect of the invention, the storage medium is a relational database, and the search index node and the information node may be respectively implemented as records in a node structure table provided in the relational database.

In the present invention, the node structure table includes fields for recording a record-specific identification code; a node name; a node identification code for distinguishing a search index node and an information node; an identification code of a hierarchy to which a node belongs in the hierarchical tree structure; a reference code for a parent node of each node in the hierarchical tree structure; and an access route to an Internet information resource.

In case that the node structure is constructed in a database, the step (a) may further include (a1) receiving a selection of a name and a parent search index node of a search index node to be formed from the user; and (a2) forming a search index node in a database as a record form by recording a record-specific identification code; a node name; a node identification code designated as a search index node; and a reference node of the selected parent search index node, in corresponding fields of the node structure table. At this time, the records corresponding to the search index node includes a record-specific identification code; a node name; a node identification code; and a parent node reference code. The node structure table may further include a field for recording a brief description of each node so that the step (a1) further receives a brief description of the search index node and the step (a2) further records the brief description in the corresponding field.

In case that the node structure is constructed in a database, the step (b) includes (b1) receiving the basic search information including an access route and a name of an Internet information resource loaded by the user using the web browser and a selection of a search index node to which the basic search information is linked in a parent-child relation, from the user; and (b2) forming a record-type information node in a database by recording a record-specific identification code; a node name; a node identification code designated as an information node; a reference node of the selected parent search index node; and an access route to the Internet information resource, in corresponding fields of the node structure table. At this time, the record corresponding to the information node includes a record-specific identification code; a node name; a node identification node; a parent node reference code; and an Internet information resource access route. The node structure table may further include a field for recording a brief description of each node, wherein the step (b1) further receives a brief description of the information node; and wherein the step (b2) further records the brief description in the corresponding field.

In case that the node structure is constructed in a database, in the step (c), the name list is made by reading records of a search index node and/or an information node linked as a child to the search index node belonging to the hierarchy according to the input order of the identifier input by the user and corresponding to a node name extended just before, extracting a node name from the read record, and outputting the node name in a list. In addition, in the step (d), the access route to the Internet information resource is extracted from the read record.

In one aspect of the invention to achieve another technical object, there is provided a method for sharing an access route to an information resource on Internet with another person through a web server by a program installed on a computer in linkage with the web server, the method comprising: (a) forming a search index node in a hierarchical tree structure in a storage medium of the computer according to a request of a user with a designated name; (b) receiving basic search information including an access route and a name of an Internet information resource loaded by the user using a web browser, and a selection of a search index node to be linked on the basis the basic search information from the user, configuring an information with the basic search information, and then storing the information node in linkage with the search index node selected by the user; (c) uploading a node structure including a search index node and an information node, constructed in a hierarchical tree structure, into a dedicated storage area distinguishable by means of a user ID of the web server according to an upload request of the user; (d) requesting and receiving a user ID list possessing the node structure uploaded in the web server to/from the web server according to a request of a user, outputting the user ID list to the user, and receiving a selection of the user about a predetermined ID included in the ID list so that a node structure that is a search target of the information node is specified; (e) providing a text search window to the user, and receiving a server-side hierarchical information node access route distinguished by a search event identifier through the search window, wherein, when there is an input of an identifier, the step (e) requests the web server with a name list of a child search index node and/or information node linked to a parent search index node prior to the input of the identifier and then stands by, and wherein, when the web server generates and transmits the requested name list in the node structure specified in the step (d), the step (e) transmits the name list to the user, then receives a selection of the user about a predetermined node name included in the name list, and adds the selected node name to the identifier so that a server-side access route of the information node is hierarchically extended step by step; and (f) when an access route to a target information node is settled, extracting an access route of an Internet information resource from the corresponding information node, obtaining a target Internet information resource through Internet with the use of the extracted access route, and then outputting the target Internet information resource to the user.

In still another aspect of the present invention to accomplish another technical object, there is also provided a method for sharing an access route to an information resource on Internet with another person through a web server by a program installed on a computer in linkage with the web server, the method comprising: (a) forming a search index node in a hierarchical tree structure in a storage medium of the computer according to a request of a user with a name of the search index node being designated; (b) receiving basic search information including an access route and a name of an Internet information resource loaded by the user using a web browser, and a selection of a search index node to be linked on the basis the basic search information from the user, configuring an information with the basic search information, and then storing the information node in linkage with the search index node selected by the user; (c) reading a node structure including a search index node and an information node recorded in the node structure table according to an upload request of the user, and uploading the node structure including into a database in linkage with the web server by means of identification of a user ID; (d) requesting and receiving a user ID list possessing the node structure uploaded in the web server to/from the web server according to a request of a user, outputting the user ID list to the user, and receiving a selection of the user about a predetermined ID included in the ID list so that a node structure that is a search target of the information node is specified; (e) providing a text search window to the user, and receiving a server-side hierarchical information node access route distinguished by a search event identifier through the search window, wherein, when there is an input of an identifier, the step (e) requests the web server with a child search index node and/or an information node linked to a parent search index node prior to the input of the identifier and then stands by, and wherein, when the web server reads and transmits records of a requested node in the node structure specified in the step (d), the step (e) extracts a name list of the node from the transmitted records, outputs the name list to the user, receives a selection of the user about a predetermined node name included in the name list, and adds the selected node name to the identifier so that a server-side access route of the information node is hierarchically extended step by step; and (f) when an access route to a target information node is settled, extracting an access route of an Internet information resource included in the corresponding information node with reference to information of the transmitted records, obtaining a target Internet information resource through Internet with the use of the extracted access route, and then outputting the target Internet information resource to the user.

As another aspect of the present invention, there is also provided a method for accessing an Internet information resource with reference to a node structure on Internet, which is formed by means of a web server by repeatedly and accumulatively executing the following processes: composing a search index node in a mass storage medium in a hierarchical category structure, composing an information node for various Internet information resources so that the information node includes a name and an access route of each Internet information resource, and then linking the information node to a lower hierarchy of a predetermined search index node, the method comprising: (a) providing a text search window to a user by means of a web browsing program installed on a computer of the user, and receiving a server-side hierarchical information node access route distinguishable by a search event identifier through the search window by means of the program, wherein, when there is an input of the identifier, the step (a) requests the web server with a name list of a child search index node and/or an information node linked to a parent search index node prior to the input of the identifier and then stands by, and wherein, when the web server generates and transmits the name list requested in the node structure, the step (a) outputs the name list to the user, receives a selection of the user about a predetermined node name included in the name list, and adds the selected node name to the identifier so that a server-side access route of the information node is hierarchically extended step by step; and (b) when an access route to a target information node is settled, extracting an access route of an Internet information resource from the corresponding information node, obtaining a target Internet information resource through Internet with the use of the extracted access route, and then outputting the target Internet information resource to the user, by means of the program.

The technical object of the present invention may be accomplished by means of a computer readable storage medium, in which the method for systematically collecting and searching for access routes of information resources on Internet is programmed and stored. The storage medium may be ROM (Read Only Memory), RAM (Random Access Memory), CD-ROM (Compact Disk-Read Only Memory), DVD-ROM (Digital Video Disk-Read Only Memory), magnetic tapes, floppy disk, optical data storage, flash memory and so on. In addition, this storage medium may store a code, which is stored and executed in a computer system connected via a network to be readable by a computer in a distribution manner.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a block diagram showing a program for implementing an embodiment of the present invention;

FIG. 2 is a tree structure diagram showing a node structure according to an embodiment of the present invention;

FIG. 3 shows a node tree view according to an embodiment of the present invention;

FIG. 4 is a schematic view showing a user interface for information node construction according to an embodiment of the present invention;

FIG. 5 shows a data structure of a node structure table according to an embodiment of the present invention;

FIG. 6 is a flowchart illustrating a web searching process and a process related to addition, deletion and update of a search index node according to an embodiment of the present invention;

FIG. 7 is a flowchart illustrating a process related to addition, deletion and update of an information node according to an embodiment of the present invention;

FIG. 8 is a flowchart illustrating a text-based searching process according to an embodiment of the present invention;

FIGS. 9a to 9e show examples of a screen provided to a user during the searching process according to an embodiment of the present invention;

FIG. 10 is a flowchart illustrating an upload process of a node structure according to an embodiment of the present invention;

FIG. 11 is a flowchart illustrating a sharing and searching process of a node structure via a web according to an embodiment of the present invention;

FIGS. 12a to 12h show examples of a screen provided to a user during the searching process of a shared node structure via a web according to an embodiment of the present invention.

### BEST MODES FOR CARRYING OUT THE INVENTION

Hereinafter, preferred embodiments of the present invention will be described in detail referring to the accompanying drawings. Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

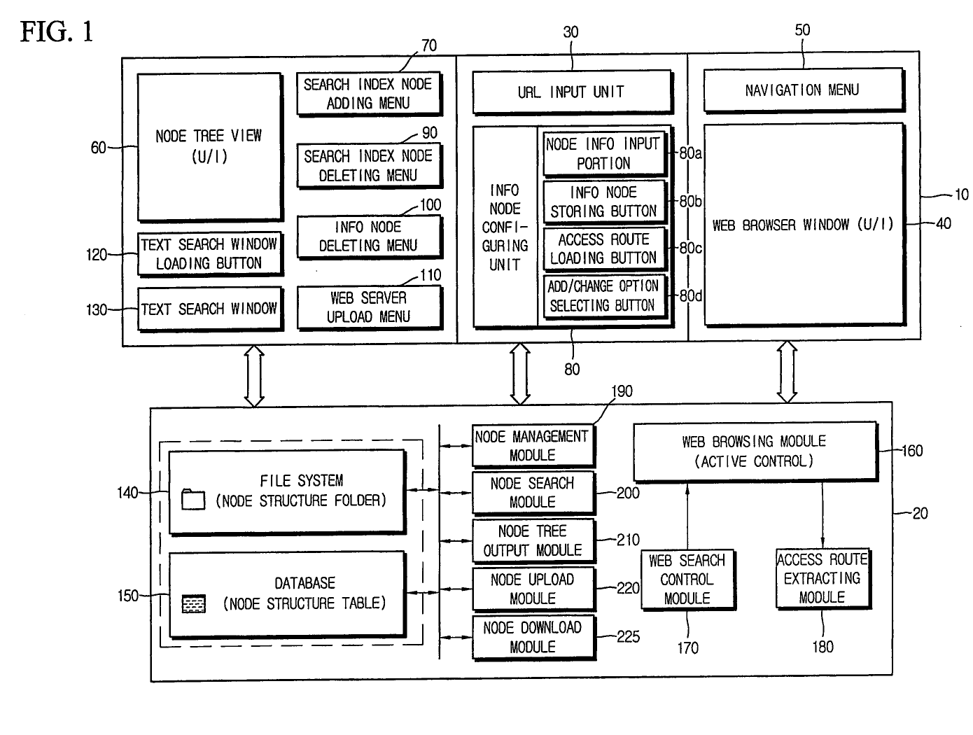

FIG. 1 shows configuration of a program that implements a method for systematically collecting and searching for access routes to information resources on Internet according to the present invention. The program is installed and executable on a user computer in which an operation system such as Windows and Linux is loaded and a communication environment is constructed to allow an access to Internet. In addition, the program is made using well-known program languages such as C#, C++ and JAVA.

Referring to FIG. 1, the program for implementing the present invention is composed of a user interface 10 and a program module unit 20 for processing interactive information, in brief

The user interface 10 basically includes a URL input unit 30 for a user to directly input a URL as an access route on Internet; a web browser window 40 for outputting Internet information resources, for example a web page, according to the URL input by a user; and a navigation menu 50 for conducting basic web navigation operations such as Forward, Back, Undo, and Home.

If a user inputs a URL for a predetermined Internet information resource in the URL input unit 30, the Internet information resource is output in the web browser window 40. In this embodiment, the Internet information resource is defined to include web pages as well as all of moving picture files, music files, document files and image files on Internet, which are known to be accessible through Internet at the time that this invention was made. The navigation menu 50 substantially has the same function as a navigation menu provided in a common web browser such as Internet Explorer of Microsoft.

The user interface 10 basically has the aforementioned configuration, and also has an interface that may configure information nodes and search index nodes in a hierarchical tree structure for the purpose of systematically collecting access routes to Internet information resources and facilitating an easy access to a desired Internet information resource by means of a text-based searching manner.

The information node is an aggregate of information, including a URL, which an access route to an Internet information resource, and a name (or, title) of an information resource. Preferably, the information node further includes a brief description endowed by a user for an Internet information resource. In the present invention, the information node may be implemented in a file form, or in a unit record of a node structure table provided in a relational database, as described later. However, in the present invention, the method for implementing the information node may be changed variously in the art to which the present invention belongs.

When information such as access routes and names (or, titles) of Internet information resources is constructed in a hierarchical tree structure, the search index node forms a divergence point of the tree and has charge of an indexing function for Internet information resources. The search index node is linked to another search index node as a parent or child node, and also linked as a parent node to an information node containing substantial information for an Internet information resource. The search index node preferably has a name endowed by a user. At this time, the name is preferably selected to suggest contents of an Internet information resource corresponding to information nodes pertaining to a lower tree structure. For example, a search index node having information nodes about various web pages containing JAVA-related technical data in a lower tree structure may be named ‘JAVA technique information’.

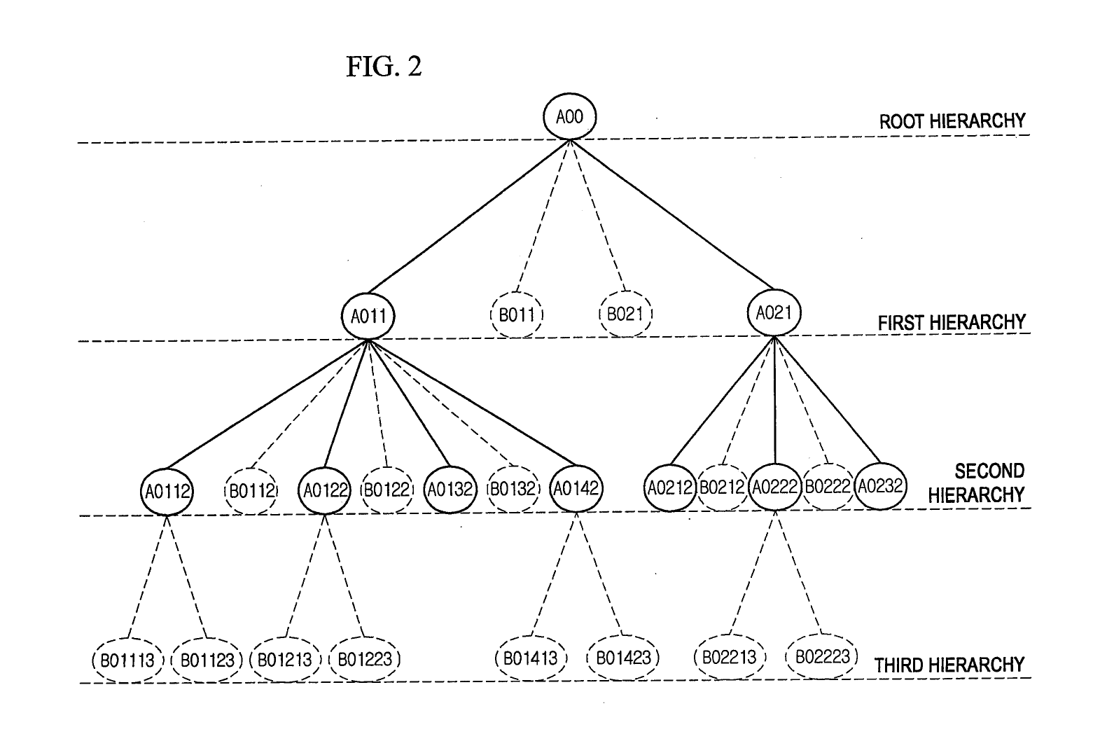

FIG. 2 is a diagram conceptually showing an example of a hierarchical tree structure composed of information nodes and search index nodes. In FIG. 2, a search index node is expressed using a solid circle, and an information node is expressed using a dotted circle. In addition, each node is distinguishably identified by means of code combination as follows: a code (A, B) specifying the kind of node + a code specifying a parent node + an order of the corresponding node in a plurality of nodes whose kind, hierarchy and parent node are identical + a code expressing a hierarchy. For example, node B01413 is an information node (see B), which has a parent node of A0142 (see first three digits of 01413), is positioned in a first order in relation with other nodes (see a second digit from behind of 01413), and is located in a third hierarchy (see a final digit of 01413). Of course, it is apparent to those ordinarily skilled in the art that nodes may be identified in various ways.

Specifically, seeing FIG. 2, a search index node (a solid circle) forms a node divergence point of the hierarchical tree structure, and the search index node may be linked to another search index node as both parent node and child node. However, an information node (a dotted circle) is linked only as a child node of a search index node. Hereinafter, the whole structure of search index nodes and information nodes as shown in FIG. 2 may also be called ‘a node structure’.

Now, interfaces used for configuring information nodes and search index nodes into a hierarchical tree structure are described below in detail, among user interfaces provided to the program of the present invention, with reference to FIGS. 1 and 2 described above.

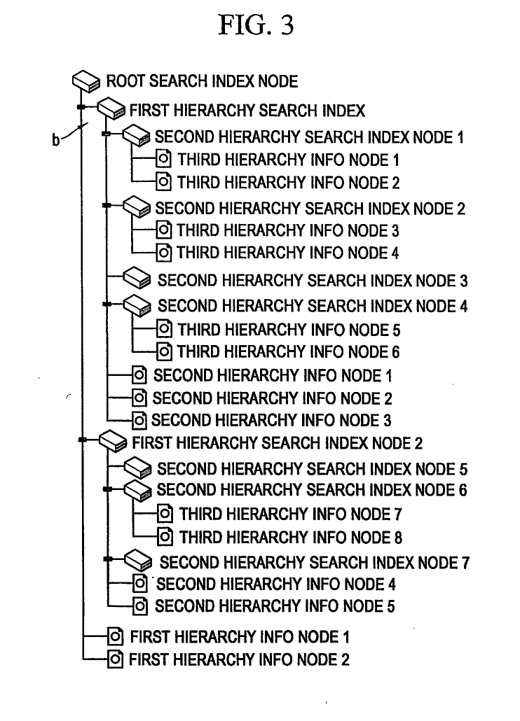

First, the user interface 10 includes a node tree view 60 for outputting a hierarchical tree structure configured by a user, as a graphic interface. FIG. 3 shows an example of the node tree view 60. In FIG. 3, a search index node and an information node are expressed with different image icons so that a user may easily distinguish them. For reference, it should be noted that the node tree view 60 shown in FIG. 3 is a node tree view 60 corresponding to a hierarchical tree structure of the search index nodes and the information nodes shown in FIG. 2.

Specifically, seeing FIG. 3, a user may check a node tree structure configured by himself/herself at a glance through the node tree view 60. In addition, the node tree view 60 has a button (B) for extending a lower tree structure or returning it to an original state. If a user selects the button (B), a lower tree is extended or returned to an original state. FIG. 3 shows an example that all lower trees existing in the node tree view 60 are extended. The technical configuration for implementing such a node tree view 60 is well known in the art as a name ‘Tree View Control’, so the technique for specifically implementing the node tree view 60 is not described in detail here.

The node tree view 60 allows a user to edit and change a name of a search index node as desired. That is to say, if a user double-clicks a search index node, whose name is to be changed, on the node tree view 60 by a mouse, the name of the search index node is switched into an editing mode, and thus the user may change a current name of the corresponding search index node into another name.

The user interface 10 of the present invention is an interface for adding or deleting a search index node to/from the node tree view 60, which includes a search index node adding menu 70 and a search index node deleting menu 90 as shown in FIG. 1. If a user selects a predetermined search index node shown on the node tree view 60 by a mouse and then selects the search index node adding menu 70, a child search index node is added to a lower hierarchy of the search index node selected by the mouse. At this time, the newly added search index node may be coded to have a predetermined name (for example, ‘new search index node’), and the user may change the name of the search index node as desired in a way mentioned above. In addition, the user may select a predetermined search index node shown on the node tree view 60 by a mouse and then selects the search index node deleting menu 90 in order to delete all tree structure in a lower hierarchy and the search index node selected by the mouse.

In the node tree view 60, an information node including at least an access route and a name (or, a title) of an Internet information resource is linked as a child node of a search index node as described above. In addition, the name of the information node may be configured to have a name endowed by a user in consideration of the Internet information user as desired. The user may select a search index node, to which an information node is to be added as a child node, by mouse and then may add, edit or delete the information node as desired.

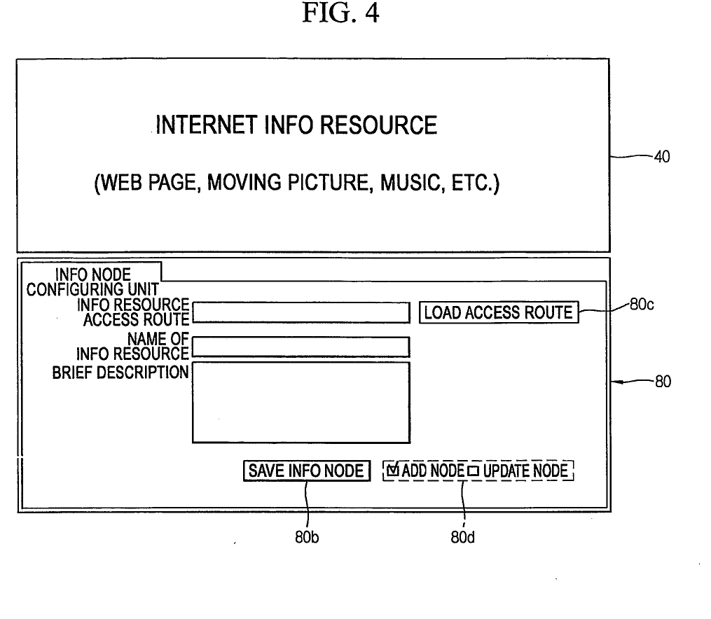

Specifically, seeing FIG. 1, the user interface 10 of the present invention includes an information node configuring unit 80 as a component for addition and editing of an information node in the node tree view 60. FIG. 4 shows an example of such an information node configuring unit 80.

Referring to FIGS. 1 and 4, the information node configuring unit 80 includes an access route loading button 80c for loading an access route (or, URL) and a title of an Internet information resource output on a web browser window; a node information input portion 80a having an information resource access route field \textcircled{1} and an information resource name (title) field \textcircled{2} in which URL and title of an Internet information resource extracted by selection of the button 80c are input respectively, and a brief description field \textcircled{3} for inputting a brief description of the Internet information resource by a user; and an information node storing button 80b for adding an information node composed of information recorded in each field as a child node of a search index node selected by a mouse when the access route loading button 80c is selected, among search index nodes in the node tree view 60. The user may edit information input into the information resource access route field \textcircled{1} and the information resource name field \textcircled{2} as desires by selection of the access route loading button 80c.

Meanwhile, if a user selects an information node on the node tree view 60, Internet information resource access route, name (title) and brief description included in the information node are input into corresponding fields of the information node configuring unit 80 respectively. Thus, the user may change information that configures the information node respectively, when required. For this purpose, the information node configuring unit 80 includes an option button 80d for selecting whether a current selection of the information node storing button 80b is for adding a node or for updating a node. A user may select an information node previously generated in the node tree view 60 to load information configuring the information node to the node information configuring unit 80, then edit the information, select a node update option in the option selecting button, and then select the information node storing button 80b so as to update the information node.

The user interface 10 of the present invention includes an information node deleting menu 100 as shown in FIG. 1 as an interface capable of deleting an information node added to the node tree view 60 through the information node configuring unit 80. If a user selects a predetermined information node in the node tree view 60 and then selects the information node deleting menu 100, the corresponding information node may be deleted from the node tree view 60.

Hereinafter, a specific embodiment related to configuring a search index node and an information node is described.

According to one embodiment of the present invention, search index nodes and information nodes constructed in a hierarchical tree structure may be constructed in a file system 140 existing in a computer, as shown in FIG. 1. In this case, the search index node may be configured as a file folder, and the information node may be configured as a file recorded in the folder. Thus, search index nodes and information nodes belonging to a parent node are positioned in a file folder corresponding to the parent node.

In this embodiment, a name of a search index node preferably configures a name of a file folder, and a name of an information node preferably configures a name of a corresponding file. In addition, a file corresponding to an information node in one-to-one relation preferably stores detailed information of the information node, that is an access route to a predetermined Internet information resource, a name (or, a title) of the information resource, and a brief description input by the user. The information recorded in the file are substantially input by a user into each field provided in the node information configuring unit as shown in FIG. 4.

According to another embodiment of the present invention, search index nodes and information nodes configured in a hierarchical tree structure may be configured as records in a table 150 (hereinafter, referred to as ‘a node structure table’) of a relational database existing in a computer, as shown in FIG. 1.

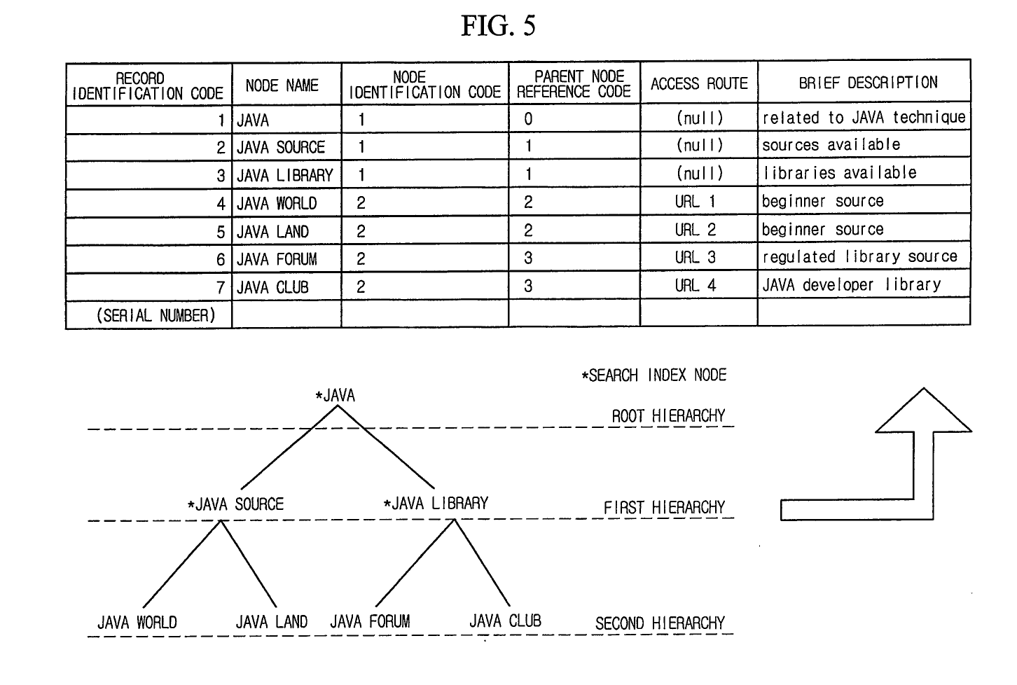

In this embodiment, the node structure table 150 includes a record-specific identification code; a node name; a node identification code for distinguishing a search index node and an information node; a reference code for a parent node of each node in the hierarchical tree structure; an access route to an Internet information resource; and a field for recording a brief description of the node. FIG. 5 shows an example that search index nodes and information nodes are constructed in the node structure table 150 that has such a field structure.

Referring to FIG. 5, a record corresponding to the search index node includes a record-specific identification code; a node name; a node identification code (1); a parent node reference code; and a brief description. In addition, a record corresponding to the information node includes a record-specific identification code; a node name; a node identification code (2); an access route; a parent node reference code; and a brief description. Though it is shown in FIG. 5 that informal information URL# is recorded in the access route field, it should be noted that a full path of an Internet information resource is actually recorded therein.

In the embodiment of the present invention, a record-specific identification code is used as the parent node reference code of each node. For example, a record node with a node name ‘JAVA land’ is an information node in terms of its attribute and its parent node reference code is 2, so a parent node of the record node ‘JAVA land’ is a search index node whose a record-specific identification code is 2 and node name is ‘JAVA source’. If several records have the same parent node reference code, the records are child nodes of a record whose record identification code is the parent node reference code. Search index node and information node in the same child hierarchy may be distinguished by means of values of the node identification code. Thus, if the parent node reference code is analyzed, the tree structure of the node structure table may be dynamically analyzed.

In the embodiment related to implementation of a database, the method for recording search index node and information node in the node structure table 150 may be changed in various ways by those who have ordinary skill in the art. Thus, the technical aspect of the present invention does not lie on a specific design of the database table, but on the fact that the node structure of the hierarchical tree structure composed of search index nodes and information nodes may be implemented by means of a relational database.

In the present invention, the node structure table 150 may be implemented using various database servers well known in the art. Such database servers may be Oracle server, MySQL server, SQL server, Interbase server, Foxpro DB server and so on, but not limitedly.

The present invention provides a user interface that allows a user to conveniently access an information node with the use of the node structure continuously and accumulatively constructed in a computer as mentioned above so that the user may access a corresponding Internet information resource in a convenient way. As an example, the user interface includes a text search window loading button 120 and a text search window 130 output to a user by selecting the button 120 as shown in FIG. 1. As an alternative, the text search window 130 may be provided to a predetermined position at all times to be movable by using a mouse without any loading request when the program according to the present invention is executed. A specific embodiment of the information node accessing method using the user interface will be described later.

Now, a method for systematically collecting and managing access routes of Internet information resources on Internet and effectively accessing an information node with the use of the text-based search window according to an embodiment of the present invention is described in detail on the basis of the above description.

This method is implemented using a program installed on and executed in a computer, and this program systematically collects access routes to information resources on Internet and also provides a user with a text-based information searching environment.

This program is mounted on a microprocessor of a computer by execution of a user, and then waits for various information processing instructions of the user, sent through the user interface 10. In view of hardware, once the program is executed, main operations of the program are controlled by the microprocessor. If there is a predetermined information processing request from a user through the user interface 10 shown in FIG. 1, the microprocessor processes information by control of a program module that treats the corresponding request, and then outputs the result to the user on a display.

The program module may include a web browsing module 160, a web search control module 170, an access route extracting module 180, a node management module 190, a node search module 200, a node tree output module 210, a node upload module 220, and a mode download module 225, whose operations will be described later in detail with reference to flowcharts.

Various data temporarily generated during the operation of the program module are recorded, updated or deleted in a working memory, and an execution code of the program is recorded in a storage medium (or, a hard disk) that the microprocessor refers to.

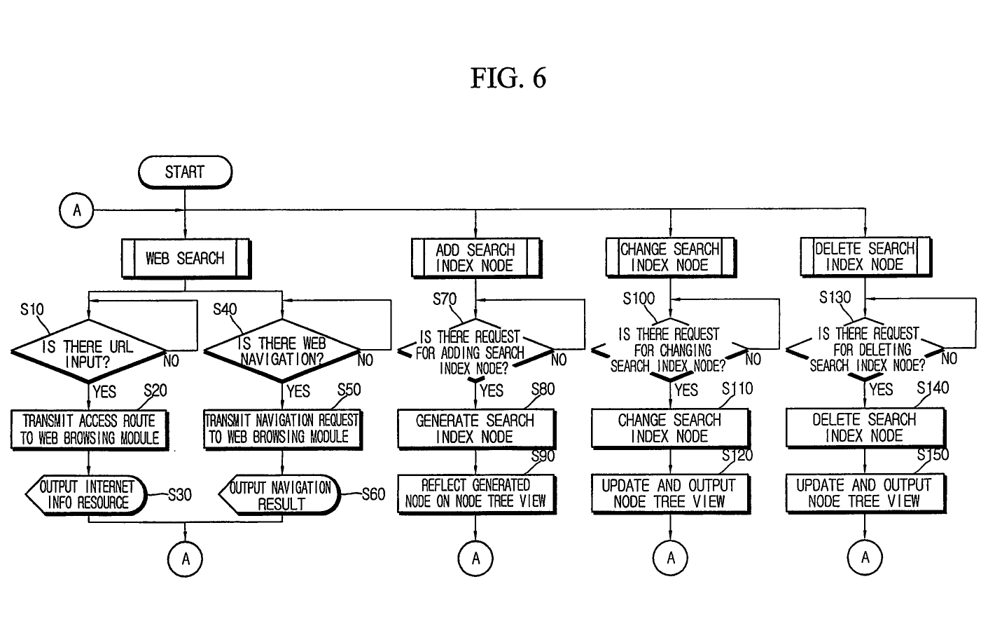

FIGS. 6 to 12 are flowcharts specifically showing a method for systematically collecting access routes of information resources on Internet by a program executed on a user computer, and providing a text-based information searching environment, and also examples of screens provided to the user.

First, a web searching process by a user is described with reference to FIGS. 1 and 6. After the program is executed, the web search control module 170 checks whether a user inputs an access route to a predetermined Internet information resource through the URL input unit 30 (S10). As a result, if it is determined that there is an input of an access route, the web search control module 170 transmits the access route of the Internet information resource, input by the user, to the web browsing module 160 (S20). Then, the web browsing module 160 outputs the Internet information resource requested by the user through the web browser window 40 (S30). Here, the web browsing module 160 may adopt ActiveX control of Microsoft or ActiveX control of Mozilla browser, well known in the art, but not limitedly.

If the Internet information resource is a web page, the web browsing module 160 outputs the information resource through the web browser window 40. If the Internet information resource is a moving picture media (e.g., an ASF file), the web browsing module 160 loads a moving picture regenerator (e.g., Window Media Player) whose execution route is already registered, and then regenerates the moving picture media. If the Internet information resource is a music media (e.g., a WMA file), the web browsing module 160 loads a music regenerator (e.g., Window Media Player) whose execution route is already registered, and then regenerates the music media. If the Internet information resource is a document data (e.g., a MS Word file), the web browsing module 160 loads a document editor (e.g., MS Word Plug-in) whose execution route is already registered in the operation system, and then downloads the document file and outputs it to the user.

Meanwhile, during the web searching process by a user, the navigation menu 50 may be used. For this purpose, the web search control module 170 checks whether there is a manipulation of the navigation menu 50 by a user (S40). As a result, if it is determined that the navigation menu 50 is manipulated, the web search control module 170 transmits a corresponding navigation request to the web browsing module 160 (S50). Then, the web browsing module 160 executes the navigation request (S60). The navigation request may be Forward, Back, Unload, Home and so on.

A user conducts web searching continuously through the above procedure. If the user finds an information resource to be registered as an information node in the node tree view 60 in this procedure, the user configures a search index node in the node tree view 60 before registering the information node.

Specifically, referring to FIGS. 1 and 6, the node management module 190 included in the program module unit 20 according to the present invention checks whether there is a selection of the search index node adding menu 70 of the user interface 10 (S70). As a result, if it is determined that there is a request for adding a search index node, the node management module 190 generates a search index node (S80). The search index node may be formed as a folder in the file system 140, or as a record in the node structure table 150 of the relational database as shown in FIG. 5.

If the search index node is generated in the step S80, the node tree output module 210 included in the program module unit 20 according to the present invention reflects the generated search index node on the node tree view 60 (S90). The search index node has a name previously determined, for example ‘new search index node’.

As an alternative, if there is a request for adding a search index node, the node management module 190 provides a separate window to the user for inputting a node name and a brief description for the node. If the user completely inputs the corresponding information, the node management module 190 may generate a search index node with the name input by the user, from the beginning.

Such a process of generating a search index node may be repeated as desired by the user within the range allowable in the file system. By means of such processes, search index nodes are formed in the node tree view 60 in a hierarchical tree structure. When a search index node is generated in the file system 140, a folder is generated in a hierarchical tree structure. In addition, when a search index node is generated in the node structure table 150 of a relational database, a record is generated as shown in FIG. 5.

The name of a search index node generated as mentioned above may be changed or deleted as desired by a user, as mentioned above.

Specifically, referring to FIGS. 1 and 6, the node management module 190 provided in the program module unit 20 according to the present invention determines whether there is a request for changing a search index node on the node tree view 60 (e.g., whether a search index node is double-clicked by a mouse) (S100). As a result, if it is determined that there is a request for changing a search index node, the node management module 190 activates the search index node into a name changing mode so that the name of the search index node may be changed. Then, the name of the search index node is changed into a name input by the user (S110). In the case that the search index node is a file folder, a name of the file folder is changed. In the case that the search index node is a record node, information recorded in a node name field for the corresponding record is updated.

If the search index node is changed as mentioned above, the node tree output module 210 outputs the search index node with the changed name in the node tree view 60 (S120). The process of changing a search index node according to the steps S100 to S120 may be repeated as desired by the user on condition that the search index node is registered in the node tree view 60.

Now, the process of deleting a generated search index node is described as follows. The node management module 190 of the present invention determines whether there is a request for deleting a search index node (S130). This node deleting request may be conducted in a way that a user selects a node to be deleted with a mouse and then selects the search index node deleting menu 90 provided in the user interface 10. As a result of the step S130, if it is determined that there is a node deleting request, the node management module 190 deletes the corresponding search index node (S 140). In the case that the search index node is a file folder, the corresponding folder is deleted. In the case that the search index node is a record node, the corresponding record is deleted from the node structure table 150. At this time, search index nodes and information nodes belonging to a lower tree structure of the search index node that receives a deleting request are deleted together regardless of folders and files.

If the search index node is deleted as mentioned above, the node tree output module 210 updates the node tree view 60 (S150). The process of deleting a search index node according to the steps S130 to S150 may be repeated as desired by the user in condition that a search index node is registered in the node tree view 60.

After configuring search index nodes as shown in FIG. 6, a user configures an information node for a predetermined Internet information resource obtained as a result of web searching, and then stores the information node in linkage with a predetermined search index node.

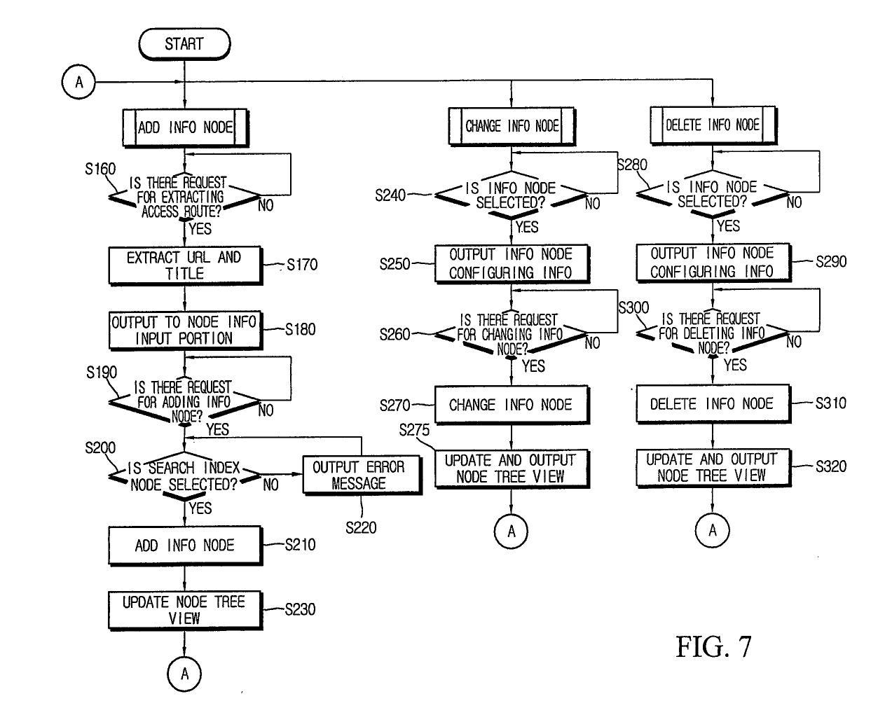

Specifically, referring to FIGS. 1 and 7, the access route extracting module 180 of the program module unit 20 according to the present invention checks in the user interface 10 whether there is a request for extracting an access route to an information resource (e.g., a web page) output on the web browser widow 40 (S160). If it is determined as a result that there is a request for extracting an access route, the access route extracting module 180 extracts URL, which is an access route, and a name (or, a title) of the Internet information resource output on the web browser window 40 in linkage with the web browsing module 160 (S170). At this time, the title of the Internet information resource may be extracted from a ‘Title’ tag of the web page. And then, the access route extracting module 180 outputs the extracted information to each field of the node information input portion 80a of the information node configuring unit 80 as shown in FIG. 4 (S180). In the node information input portion 80a, the access route of the Internet information resource is output to an ‘information resource access route’ field, and the name (or, the title) is output to an ‘information resource name’ field. Accordingly, the user edits the information output to each field in the node information input portion 80a, or briefly adds a description of the Internet information resource in a brief description field.

Meanwhile, the node management module 190 of the present invention determines whether there is a request for adding an information node in the information node configuring unit 80 shown in FIG. 4 (S190). At this time, the request for adding an information node may be made by means of a selection of the information node storing button 80b shown in FIG. 4. As a result, if it is determined that there is a request for adding an information node, the node management module 190 checks whether a search index node to which the information node is added is selected (S200). At this time, the selection means that a predetermined search index node is selected in the node tree view 60 before the information node storing button 80b is selected.

As a result of the step S200, if a search index node to which an information node is added is selected, the node management module 190 configures the information node with an access route, a name (or, a title) and a brief description of an Internet information resource, and then adds (or, stores) the information node in linkage with a search index node selected by the user (S210). If the search index node is a file folder, the information node is recorded as a file in the folder of the selected search index node. In addition, if the search index node is implemented as a record, the information node is recorded as a record in the node structure table 150 of the database as shown in FIG. 5. If the information node is completely added as mentioned above, the node tree output module 210 updates the node tree view 60 to output the added information node (S230). If a search index node is not selected as a result of the step S200, the node management module 190 outputs an error message informing that a search index node should be selected (S220).

The process of adding an information node as mentioned above may be repeated continuously in connection with the web searching process and the search index node adding process. Thus, the hierarchical tree structure composed of search index nodes and information nodes becomes greater as time goes.

Meanwhile, the added information node may be updated or deleted like the search index node in the present invention.

Referring to FIGS. 1 and 7 again, the node management module 190 determines whether an information node is selected (S240). As a result, if a predetermined information node is selected, access route and name (or, title) of an Internet information resource and its brief description are output to the information node configuring unit 80 as shown in FIG. 4, as information of the information node (S250). At this time, the user may change the information output in the information node configuring unit 80 as required. After the step S250, the node management module 190 determines whether there is a request for changing an information node (S260). Here, the request for changing an information node may be made by selecting the ‘node update’ option in the option selecting button 80d of the information node configuring unit 80 shown in FIG. 4, and then selecting the information node storing button 80b.

As a result of the step S260, if it is determined that there is a request for changing an information node, the node management module 190 changes the change-requested information node (S270). If the information node is implemented as a file, contents recorded in the file and a name of the file may be changed. In addition, if the information node is implemented as a record as shown in FIG. 5, the corresponding record is updated. If the information node is completely changed, the node tree output module 210 updates and outputs the node tree view 60 (S275).

Now, a process of deleting an information node is described. The node management module 190 determines whether an information node is selected (S280). As a result, if a predetermined information node is selected, the node management module 190 outputs access route and name (or, title) of an Internet information resource and its brief description, which are information composing the information node, to the information node configuring unit 80 as shown in FIG. 4 (S290). And then, the node management module 190 determines whether there is a request for deleting the information node selected in the step S280 (S300). As a result, if it is determined that there is a request for deleting an information node, the node management module 190 deletes the information node (S310). If the information node is implemented as a file, the corresponding file is deleted. In addition, if the information node is implemented as a record as shown in FIG. 5, the corresponding record is deleted. If the information node is completely deleted as mentioned above, the node tree output module 210 updates and outputs the node tree view 60 (S320).

If the node structure is generated in a storage medium of a computer in a hierarchical tree structure as mentioned above, the program provides a user with a convenient text-based information searching environment for an information node, containing an access route to an Internet information resource.

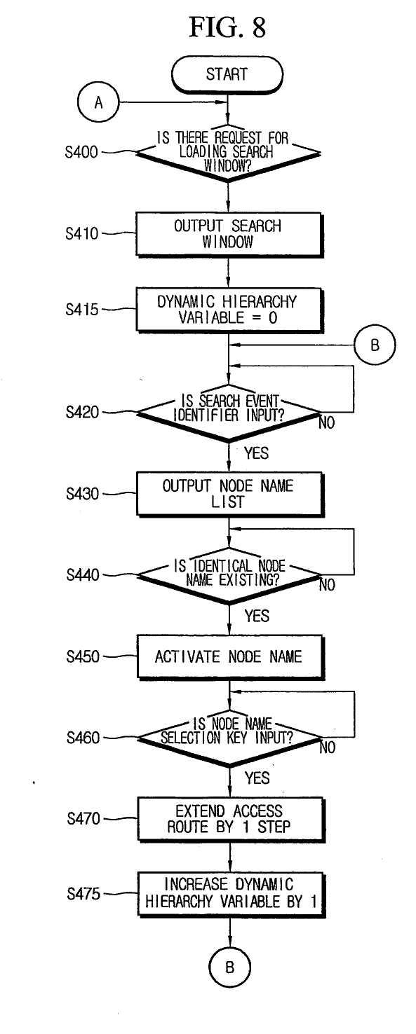

Specifically, referring to FIG. 8, the node search module 200 included in the program module unit 20 of the present invention determines whether there is a request for loading a search window by a user (S400). Here, a user may load the search window by selecting a text search window loading button 120 as shown in FIG. 1. As a result, if it is determined that there is a request for loading a search window, the node search module 200 outputs the search window that allows easy search of a target information node (or, an Internet information resource) by conveniently inputting a hierarchical information node access route composed of successively connected search index node names, each having a search event identifier as a prefix, in an automated way, and then waits for input of a search event identifier (S410).

Meanwhile, the search window may be provided always at a predetermined region when the program of the present invention is executed, together with being movable by a mouse. Here, the technical scope of the present invention lies in the fact that such a search window is provided, not in a specific procedure for outputting the search window.

The hierarchical information node access route has a format as follows.

[.node name 1.node name 2.node name 3.node name 4.node name 5 . . .]

In the above example, a search event identifier is a period (.), and the node name is a name of a search index node having a hierarchical tree structure. Here, the search event identifier may be changed in various ways.

If a search window is output in the step S410, the node search module 200 sets a dynamic hierarchy variable to zero (0) (S415). And then, the node search module 200 checks whether there is an input of a search event identifier (S420). If there is an input of the search event identifier (.), the node search module 200 makes a list with search index nodes and information nodes in a top hierarchy (a root hierarchy), and then outputs the list near the search window (S430). In the case that a node structure is implemented in the file system 140, the node name may be extracted from a name of a file folder in the root hierarchy or a file corresponding to an information node. In addition, in the case that the node structure is implemented in the node structure table 150 in a database as shown in FIG. 5, the node name may be extracted from a node name field of a record in the root hierarchy whose parent node reference code is 0.

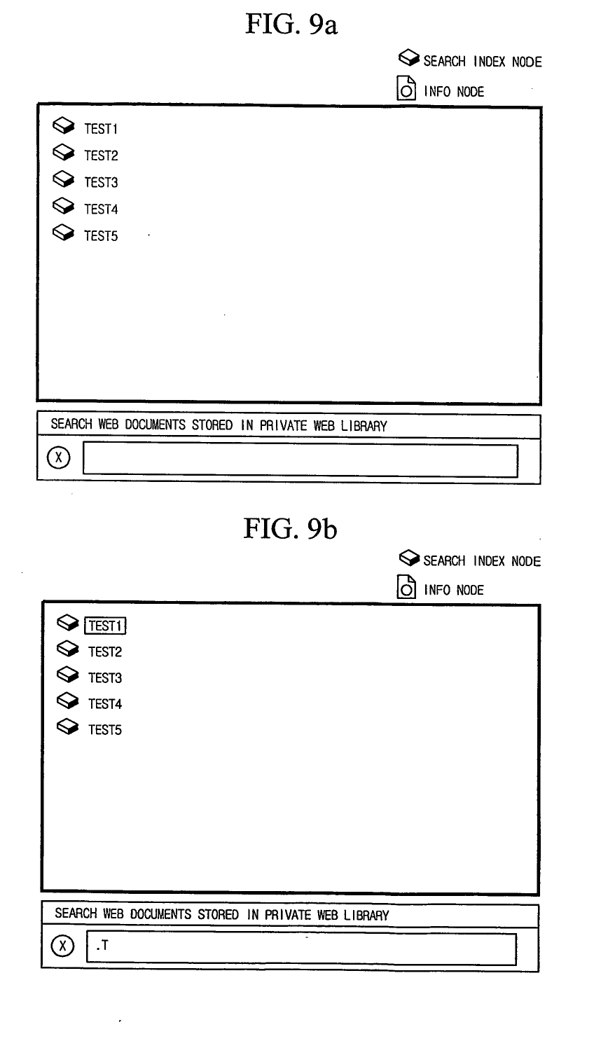

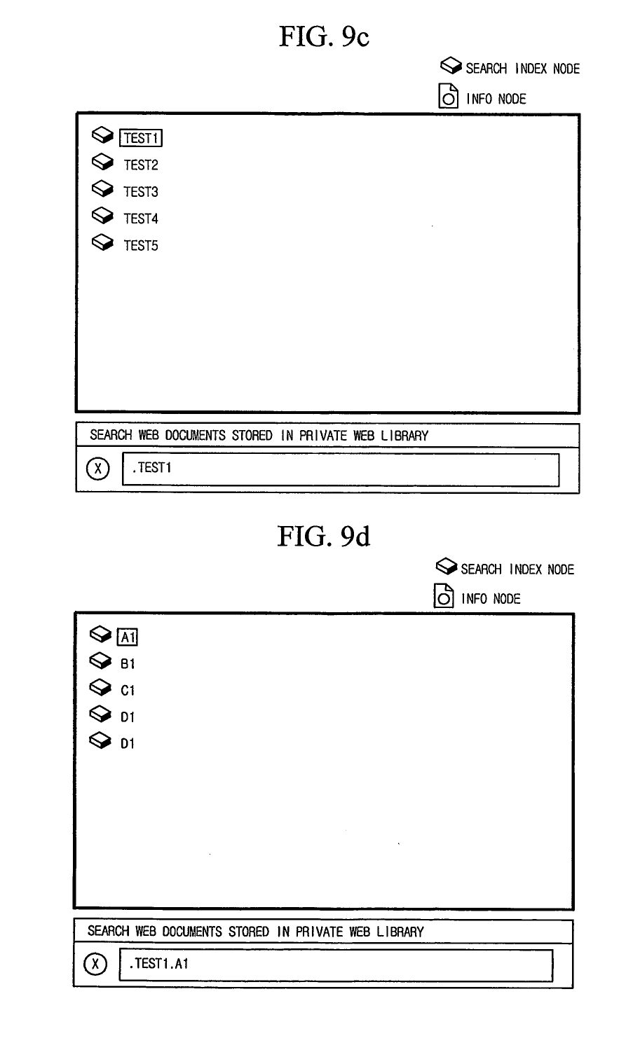

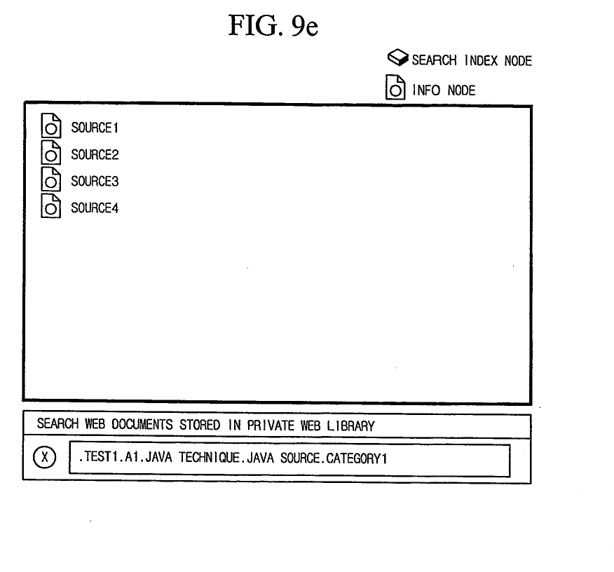

FIG. 9a shows an example of a node name list output near the search window. As shown in FIG. 9a, it would be understood that there exist four search index nodes in a root hierarchy of a node structure.

After the step S430, a user inputs a text in the search window syllable by syllable. At this time, the node search module 200 checks whether there is a node name identical to the text input by the user among the node names output in the node name list, whenever one syllable is input (S440). As a result, if there is a node name identical to the input text, the node search module 200 moves a node selection cursor to the corresponding node name to activate the node name (S450). In an example shown in FIG. 9a, if the user inputs a character ‘T’ in the search window, a node name at the top is directly activated as shown in FIG. 9b.

If a node name is activated, the node search module 200 checks whether a node name selection key (e.g., an enter key) previously defined is manipulated (S460). As a result, if the node selection key is manipulated, the node search module 200 adds the node name activated in the step S450 to the search event identifier so that an access route to an information node may be extended by one step (S470). After that, the node search module 200 increases the dynamic hierarchy variable by 1 (S475).

In the example shown in FIG. 9b, if the user manipulates the enter key, the node name is automatically added to the search event identifier as shown in FIG. 9c, so an access route to an information node is extended by one step in the node structure composed in a hierarchical tree structure.

If the access route to an information node is extended by one step in the step S470, the node search module 200 returns the process to the step S420. After that, the node search module 200 checks again whether there is an input of a search event identifier in the search window. As a result, if there is an input of the search event identifier, the node search module 200 searches search index nodes and information nodes linked to the search index node, selected by the user in a right upper hierarchy, as a parent node among nodes existing in a hierarchy corresponding to the number recorded in the dynamic hierarchy variable, and then the node search module 200 reads names of the nodes, and makes and outputs a node name list.

For example, in the case that the node structure is configured in a file system, the node search module 200 reads names of subordinate folders and information node files belonging to a folder corresponding to the search index node selected by the user in a just upper hierarchy and then configures a node name list. In addition, in the case that the node structure is configured in a data structure as shown in FIG. 5, the node search module 200 extracts node names from a record(s) having a record identification code of the search index code selected by the user in a right upper hierarchy as a parent node reference code and then configures a node name list.

Subsequently, the node search module 200 recognizes an input of a syllable-unit text from a user, and then moves a node selection curser to a node name including the text input by the user in the node name list and activates the node name. Then, if the user manipulates the node name selection key, the node search module 200 adds the activated node name to the search event identifier so that the access route to a target information node is further extended by one step. And then, the dynamic hierarchy variable is increased by 1, and then the process is returned again to the step S420. Such a series of procedure is repeated until an information node desired by the user is shown in the node name list.

In an example shown in FIG. 9c, if the user inputs a search event identifier (.) again, child nodes whose parent node is the search index node ‘test 1’ are shown in the node name list as shown in FIG. 9d. If the user inputs a character ‘A’ again in the search window, the node selection cursor is moved to a node name ‘A1’. Then, if the user manipulates the node name selection key (e.g., a return key), the information node access route is extended again by one step.

FIG. 9e shows an example that a target information node desired by the user is output in the node name list after the access route to an information node is repeatedly extended in the search window as shown in FIG. 8. The user has expanded the search index node in the search window by five steps, and obtains a name list with four information nodes, namely from source 1 to source 4. In addition, in the search window, an information node access route in which five node names, each having a search event identifier as a prefix, are successively connected is input.

The user may select one of the information nodes and then access an Internet information resource corresponding to the selected information node. That is to say, the user may select a corresponding information node by a mouse, or by inputting a character included in the information node to be accessed so that the node selection cursor is moved to the corresponding node name and then manipulating the node name selection key.

If a predetermined information node is selected in such a way, the node search module 200 transmits the access route of the Internet information resource included in the information node to the web search control module 170. If the information node has a file format, an access route of the Internet information resource recorded in the corresponding file is transmitted. If the information node has a record format, an access route recorded in the access route field of the Internet information resource recorded in the corresponding record is transmitted. Then, the web search control module 170 controls the web browsing module 160 to output an Internet information resource according to the information node selected by the user to the web browser window 40 provided to the user interface 10. For example, if an Internet information route included in the information node is ‘http://***.co.kr/***.html’, a web page corresponding to this URL is output to the web browser window 40.

If an Internet information resource according to the information node selected by the user is not a web page, a moving picture regenerator, a music regenerator or a document editor is executed depending on the kind of Internet information resource to output the Internet information resource.

In the above embodiment, it is described that an access route to an Internet information resource is systematically collected and managed in a node structure, and a target information node is accessed through the text-based search window in a fast and convenient way only in a client level. However, the present invention is not limited to that case, but it is also possible that a plurality of users share node structures through a web.

For this purpose, a user preferably accesses a web site provided by a web server, and subscribes for the web server as a member to get a member ID and a password. Then, the web server records member information of the user in a member DB.

After subscribing for the web server as a member, the user registers the member ID and the password endowed during subscription to the program of the present invention. Then, the user may share a node structure of another user through a web via the web server.

Now, the process of uploading a node structure constructed on a computer by a user to the web server through Internet for sharing the node structure with other users is described.

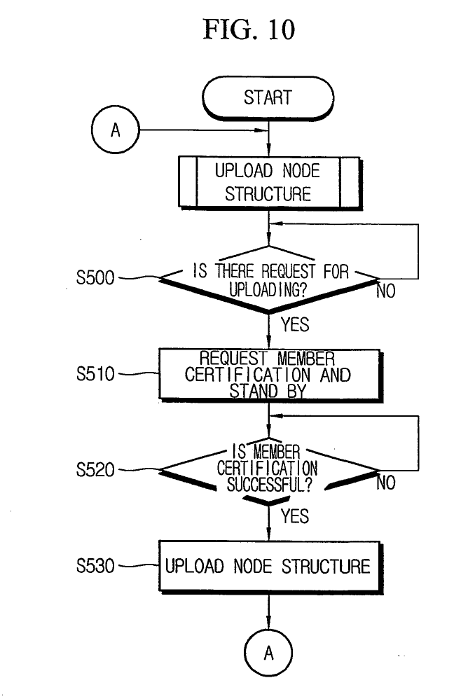

Specifically, referring to FIG. 10, the node upload module 220 included in the program module unit 20 of the present invention checks whether there is a request for uploading a node structure by a user (S500). Here, the request for uploading a node structure may be conducted by means of the selection of the web server upload menu 110 of the user interface shown in FIG. 1.

If there is a request for uploading a node structure from a user as a result of the step S500, the node upload module 220 establishes a communication line with the web server through Internet. Then, the node upload module 220 transmits the registered ID and password of the user to the web server and requests member certification, and then waits for a response (S510). Then, the web server progresses a member certification process of the user with reference to the member DB, and then, if the member certification is successful, the web server endows a certification cession to the communication line connected to the node upload module 220.

After the step S510, the node upload module 220 determines whether the member certification is conducted successfully (S520). As a result, if it is determined that the member certification is successful, the node upload module 220 transmits the node structure to the web server through Internet (S530).

In the case that the node structure is generated in the file system 140, the node upload module 220 compresses search index nodes (or, file folders) and information nodes (or, files) configured in a hierarchical tree structure into one file. After that, the node upload module 220 transmits the compressed node structure to a node structure receiving module loaded in the web server. Here, the node structure receiving module is coded using a known web program language such as ASP.NET, PHP and JAVA.

Then, the node structure receiving module allocates a storage area (or, a file folder) recognizable by the user ID in a mass storage medium (e.g., a disk array) that the web server refers to, and then decompresses the node structure and stores it in the storage area. Thus, a node structure substantially identical to the node structure stored in the computer of the user is generated in the storage area recognizable by the user ID.

Meanwhile, in the case that the node structure is generated in the node structure table 150 in a relational database, the node upload module 220 reads search index nodes (or, records) and information nodes (or, records) that compose the hierarchical tree structure as shown in FIG. 5. After that, the node upload module 220 configures a text stream or one text file with information recorded in each read record, and then transmits it to a node structure receiving module loaded in the web server. At this time, the text stream or the text file may be configured so that each record is distinguishable by a record identifier (;), and information of each field in the same record is distinguishable by a field identifier (e.g., a special character) such as Chr(20) or Chr(24) code.

Then, the node structure receiving module decodes the text stream or the text file transmitted by the node upload module 220, and reconfigures it into a record format. Then, the node structure receiving module records the reconfigured records in a server-side node structure table provided to the mass storage medium referred by the web server so as to be identified by means of the user ID. Accordingly, in the server-side node structure table recognized by the user ID, the search index nodes and the information nodes recorded in the node structure table 150 of the user computer are substantially identically recorded.

This process of uploading a node structure is accomplished by a plurality of users who use the program of the present invention, and there exist a plurality of node structures in the web server accordingly. Thus, the user may not only use the node structure constructed in his/her own computer but also share node structures of other users, constructed in the web server, through Internet.

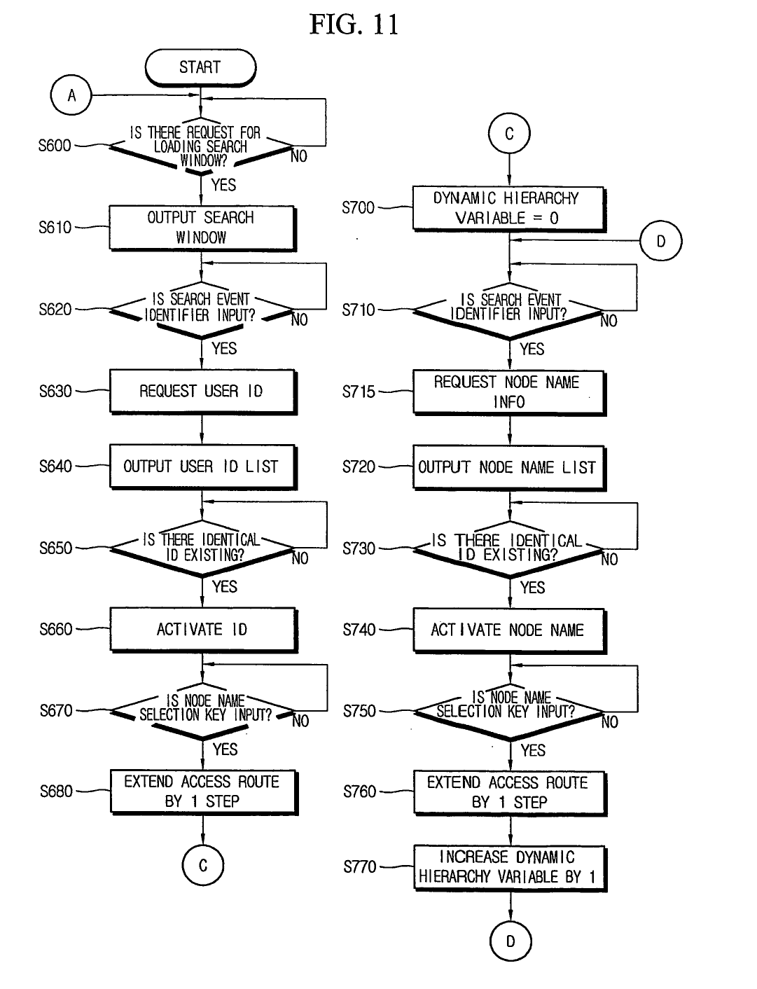

Specifically, referring to FIG. 11, the node search module 200 included in the program module unit 20 of the present invention determines whether there is a request for loading a search window from a user (S600). As a result, if it is determined that there is a request for loading the search window, the node search module 200 outputs the search window, which allows the user to search a target information node (or, an Internet information resource) from node structures of other users constructed in the web server in a convenient way by conveniently inputting a server-side information node access route having successive search index node names, each having a search event identifier as a prefix, in an automated way, and then waits for an input of a search event identifier (S610). Meanwhile, the search window mentioned above is always output at a predetermined region when the program of the present invention is executed, and it may also be output to be movable by a mouse.

The server-side information node access route has a following format. [.user ID.node name 1.node name 2.node name 3.node name 4.node name 5 . . . ]

In the above example, the search event identifier is a period (.), and the node name is a name of a search index node in the node structure that exists in the web server. Here, it is preferable that the search event identifier is different from a search event identifier used for accessing an information node in a node structure constructed in the user computer itself.

If the search window is output in the step S610, the node search module 200 checks whether there is an input of a search event identifier (S620). If there is an input of the search event identifier (,), the node search module 200 requests an ID list of users who registered node structures in the web server (S630). Then, the server-side node search module loaded on the web server transmits the user ID information of users who registered node structures to the node search module 200.

In the case that the node structure registered in the web server is implemented in a file system, the user ID may be extracted from a name of a file folder allocated to each user in a root hierarchy of the mass storage medium that the web server refers to. In addition, in the case that the node structure is implemented in a server-side node structure table of the mass storage database that the web server refers to, the user ID may be obtained by reading user IDs endowed to each record in order to identify information index nodes (or, records) and information nodes (or, records) that compose a node structure of each user so that the user IDs are not duplicate. However, the present is not limited to that case.

When receiving the user ID information from the web server, the node search module 200 makes a list with the user ID information and outputs the user ID list near the search window (S640).

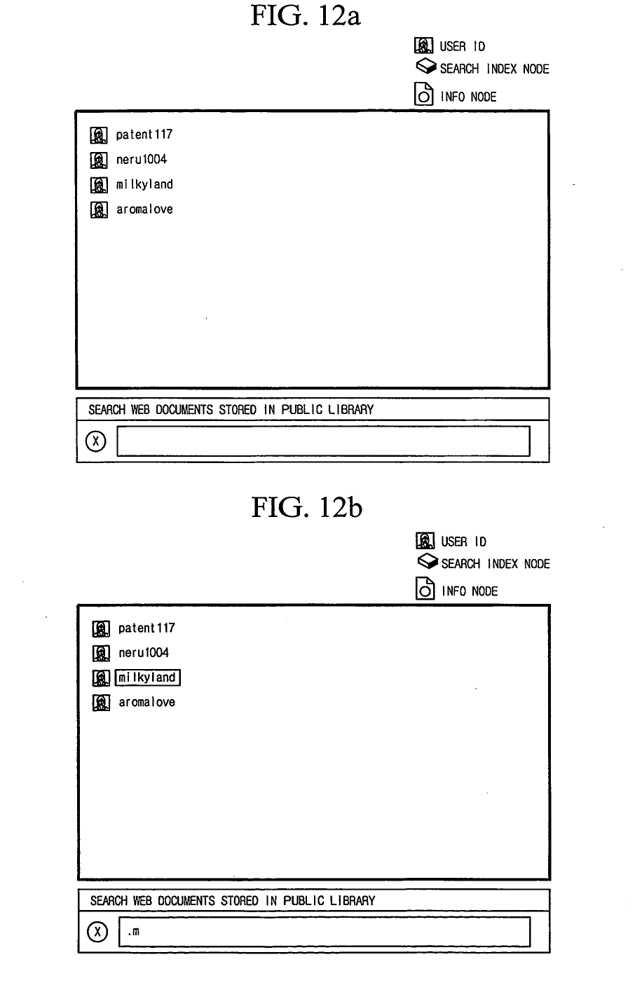

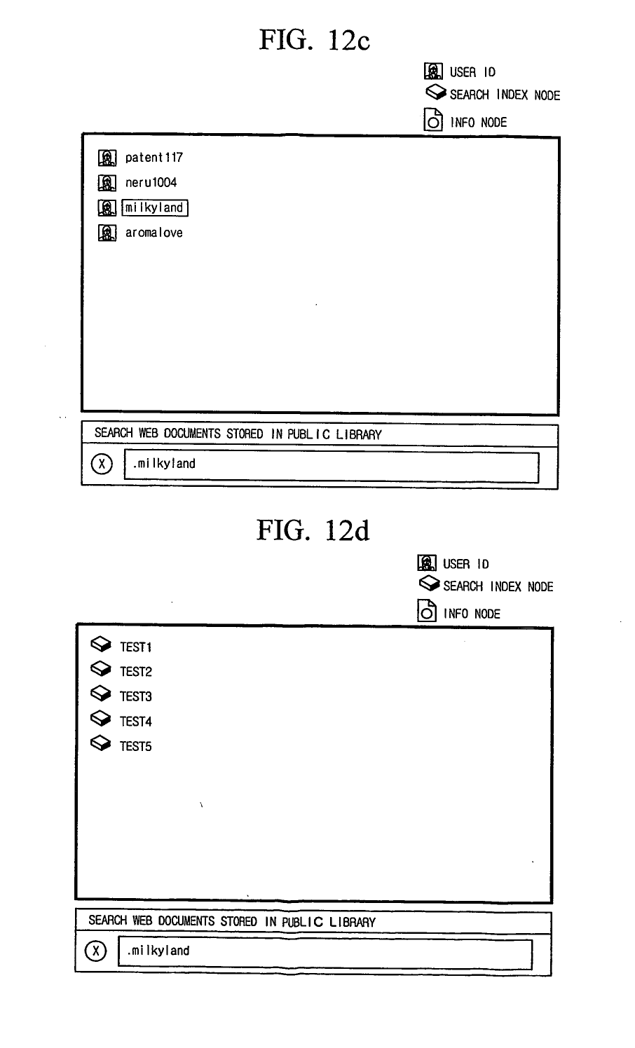

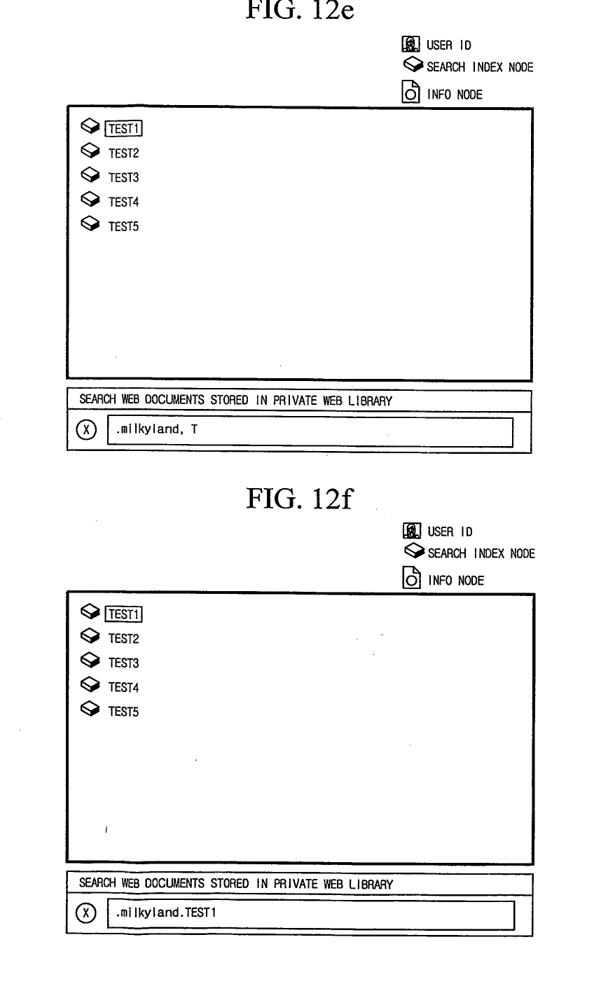

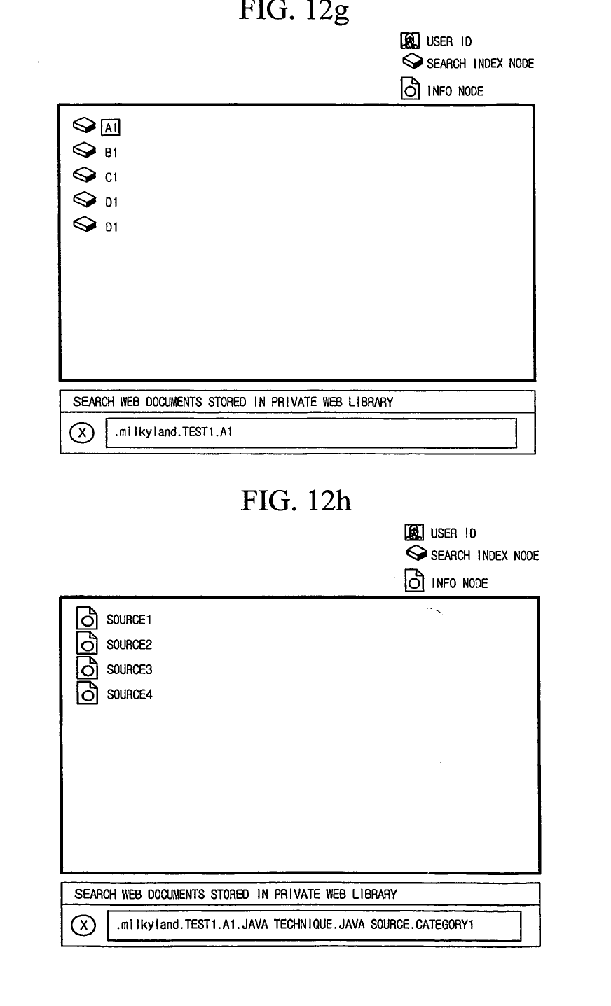

FIG. 12a shows an example of the user ID list output near the search window. As shown in FIG. 12a, it might be understood that there are 4 users who registered node structures in the web server.

After the step S640, the user inputs a text in the search window syllable by syllable. At this time, whenever one syllable is input, the node search module 200 checks whether there is an ID identical to the text input by the user among IDs output in the user ID list (S650). As a result, if there is an identical ID, the node selection cursor is moved to that ID to activate the ID (S660). In the example shown in FIG. 12a, if the user inputs a character ‘m’ in the search window, a user ID ‘milkyland’ is directly activated as shown in FIG. 12b.

If the user ID is activated, the node search module 200 checks whether a previously defined node name selection key (e.g., an enter key) is manipulated (S670). As a result, if the node name selection key is manipulated, the node search module 220 adds the user ID activated in the step S660 to the search event identifier so as to extend an access route to a server-side information node by one step (S680).

In the example shown in FIG. 12b, if the user manipulates the node name selection key, the user ID is automatically added to the search event identifier as shown in FIG. 12c, thereby specifying a user ID of the node structure that is a target for searching an information node.

If the server-side node structure used for searching an information node is specified as mentioned above, the node search module 200 progresses the process to the step S700.

Specifically, the node search module 200 sets the dynamic hierarchy variable to zero (0) (S700), and then checks whether there is an input of a search event identifier (S710). As a result, if there is an input of a search event identifier, the node search module 200 requests the web server to transmit name information of search index nodes and information nodes existing in a root hierarchy of the node structure identified by the user ID specified in the step S680 (S715). Then, the server-side node search module of the web server extracts information related to the search index nodes and the information nodes existing in the root hierarchy of the corresponding node structure, and then transmits them to the node search module 200. At this time, the transmitted information includes a tree structure index code and a name of the search index node, a name and a tree structure index code of the information node, and detailed information composing the information node. Then, the node search module 200 outputs a name list of the nodes in the root hierarchy to a position near the search window (S720).

FIG. 12d shows an example of the node name list output near the search window. As shown in FIG. 12d, it might be understood that 4 search index nodes exist in the root hierarchy of the node structure.

After the step S720, the user inputs a text in the search window syllable by syllable. At this time, whenever one syllable is input, the node search module 200 checks whether there is a node name identical to the text input by the user among the node names output in the node name list (S730). As a result, if there is an identical node name, the node selection cursor is moved to the node name to activate the node name (S740). In the example shown in FIG. 12d, if the user inputs a character ‘T’ in the search window, a node name at the top is directly activated as shown in FIG. 12e.

If the node name is activated, the node search module 200 checks whether a previously defined node name selection key (e.g., an enter key) is manipulated (S750). As a result, if the node name selection key is manipulated, the node search module 200 adds the node name activated in the step S740 to the search event identifier, thereby extending an access route to an information node by one step (S760). After that, the node search module 200 increases the dynamic hierarchy variable by 1 (S770).

In the example shown in FIG. 12e, if the user manipulates the enter key, the node name is automatically added to the search event identifier as shown in FIG. 12f, so the access route to an information node is extended by one step in the node structure composed in a hierarchical tree structure.

If the access route to an information node is extended by one step in the step S770, the node search module 200 returns the process to the step S710. After that, the node search module 200 checks again whether there is an input of a search event identifier in the search window. As a result, if there is an input of a search event identifier, the node search module 200 requests the web server to transmit information about search index nodes and information nodes, linked to the search index node selected by the user in a just upper hierarchy as a parent node, among nodes existing in the hierarchy corresponding to the number recorded in the dynamic hierarchy variable.

Then, the server-side node search module of the web server extracts information related to the corresponding nodes in the node structure and then transmits the information to the node search module 200. For example, in the case that the node structure is constructed in a file system that the web server refers to, the server-side node search module extracts information related to subordinate folders and information node files belonging to a folder corresponding to the search index node selected by the user in a just upper hierarchy, and then transmits the information to the node search module 200. In the case that the node structure is constructed in a database that the web server refers to, the server-side node search module extracts node information from a record(s) whose parent node reference code is a record identification code of the search index node selected by the user in the just upper hierarchy, and then transmits the node information to the node search module 200.

Subsequently, the node search module 200 extracts node names from the information transmitted from the web server, and then makes a list with the node names and outputs the list to the user. After that, the node search module 200 recognizes the input of a syllable-unit text, and then moves the node selection cursor to a node name having the text input by the user in the node name list and activates the node name. Then, if the user manipulates the node name selection key, the node search module 200 adds the node name to the search event identifier to extend an access route to a target information node by one step. And then, the dynamic hierarchy variable is increased by 1, and then the process is returned to the step S710. Such a series of procedures are repeated until an information node desired by the user is shown in the name list.

In an example of FIG. 12f, if the user inputs the search event identifier (,) again, information about child nodes whose parent node is the search index node ‘test1’ in the server-side node structure is transmitted from the web server to be shown in the name list near the search window as shown in FIG. 12g. In addition, if the user inputs a text ‘A’ in the search window again, the node selection key is moved to a node name ‘A1’, and if the user manipulates the node name selection key (e.g., a return key), the information node access route is extended by one step.

FIG. 12h shows an example that a target information node desired by the user is output in the node name list as a result of repeatedly extending the access route to an information node existing in the server-side structure on the search window as shown in FIG. 11.

In FIG. 12h, the user has extended the search index node in the search window by six steps, including the user ID, and obtains a name list for four information nodes named ‘source 1’ to ‘source 4’. In addition, in the search window, an information node access route in which 6 node names, each having the search event identifier as a prefix, are successively connected is output.

After selecting one of the information nodes, the user may access an Internet information resource according to the corresponding information node. That is to say, the user may select the corresponding information node by a mouse, or may select the information node by inputting a text included in the information node to be accessed so that the node selection curser is moved to the corresponding information node and then manipulating the node name selection key.

If a predetermined information node is selected in such a way, the node search module 200 transmits the access route of an Internet information resource, included in the information node, to the web search control module 170. Then, the web search control module 170 controls the web browsing module 160 to output the Internet information resource according to the information node selected by the user on the web browser window 40 provided to the user interface 10. For example, if the Internet access route included in the information node is ‘http://***.co.kr/***/htm1’, the web search control module 170 makes a web page corresponding to this URL be output on the web browser window 40.

If the Internet information resource according to the information node selected by the user is not a web page, a moving picture regenerator, a music regenerator or a document editor is executed to output the Internet information resource according to the kind of the Internet information resource.

Meanwhile, according to the present invention, the node structure registered in the web server may be downloaded to a lower hierarchy of a search index node existing in a node structure configured on a user computer. This function is implemented by the node download module 225 included in the program according to the present invention. For example, a user may select one search index node (e.g., test 1) in the node name list as shown in FIG. 12e and then request to download the selected search index node. Then, the node download module 225 allows the user to elect a client-side search index node to which the selected node and all of its subordinate nodes are downloaded. If the user selects a predetermined search index node accordingly, the node download module 225 requests the web server to download the node. Then, a download processing module of the web server reads the requested node and all of its subordinate nodes and then transmits them to the node download module 225. Then, the node download module 225 stores the transmitted nodes to be linked to a lower hierarchy of the search index node selected by the user. At this time, the downloading procedure is similar to the procedure that a node structure is uploaded from the user computer to the web server.

As a modification, the web server may have a node structure to itself. In this case, the program of the present invention may be coded so that a search mode for the node structure of the web server itself starts when a predetermined search event identifier (;) is input in the search window. In this case, if the search event identifier (;) is input, the node search module 200 requests information about a root node of the node structure of the web server itself to the web server. The procedures after this are substantially identical to the node structure searching procedure of the web server, which is conducted after a node structure to be searched is specified by a user ID in the aforementioned web sharing process of the node structure.

This embodiment will be more useful when the web server provides a search service in a hierarchical directory structure. The node structure of the web server itself classifies information about Internet information resources including various Internet sites, web pages, multimedia medias in a hierarchical category structure. Here, the category has a name corresponding to a name of the search index node. In addition, each category includes an information node, which has a name of Internet information resource belonging to the category, a URL for accessing the resource, and a brief description. The node structure of the web server itself, configured as above, is preferably updated continuously and accumulatively by an operator of the web server.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

In one aspect of the present invention, a user may manage access routes to various Internet information resources, obtained by a result of web searching, in a systematical and hierarchical way.

In another aspect of the present invention, a user may rapidly access enormous Internet information resources constructed in a form of a node structure, under the text-based searching environment, thereby capable of maximizing utilization of the previously constructed Internet information resources.

In still another aspect of the present invention, an information node access route is automatically completed on the basis of a search event identifier in the text-based searching environment, so a user may access a target information node more conveniently.

In further another aspect of the present invention, since a plurality of users may share node structures on web, it is possible to propagate intelligences for Internet information resources rapidly, and a user may efficiently obtain information through Internet since an access route of an Internet information resource, not possessed by the user, may be obtained through a node structure of another user.

In still another aspect of the present invention, the web server provides a node structure to itself, thereby enabling to give a new type web information searching service, completely different from a conventional information searching method provided in an existing search engine site.

1. A method for systematically collecting and searching for an access route of an information resource on Internet so that a program executed on a computer systematically collecting access routes of information resources on Internet and provides a text-based information searching environment, the method comprising:
(a) forming a search index node in a hierarchical tree structure in a storage medium of the computer according to a request of a user;
(b) receiving basic search information including an access route and a name of an Internet information resource loaded by a user using a web browser, and a selection of a search index node to be linked with the basic search information from the user, and then configuring and storing an information node in linkage with the search index node selected by the user on the basis of the basic search information;
(c) providing a text search window to the user, receiving a hierarchical information node access route distinguished by a search event identifier through the search window, outputting a name list of search index nodes and/or information nodes in a hierarchy corresponding to an input order of the identifier when there is an input of the identifier, receiving a selection of the user for a node name included in the name list, and then adding the selected node name to the identifier so that the access route to the information node is hierarchically extended step by step: and
(d) when an access route to a target information node is settled, extracting an access route of an Internet information resource corresponding to the corresponding information node, obtaining a target Internet information resource through Internet with the use of the extracted access route, and then outputting the target Internet information resource to the user.

2. The method for systematically collecting and searching for an access route of an information resource on Internet according to claim 1,
wherein the search index node is composed of a file folder with a name designated by the user.

3. The method for systematically collecting and searching for an access route of an information resource on Internet according to claim 2,
wherein the information node is composed of a file capable of extracting information about a name and an access route (URL: Uniform Resource Locator) of the information resource on Internet.

4. The method for systematically collecting and searching for an access route of an information resource on Internet according to claim 3,
wherein the hierarchical tree structure of the search index node formed in the step (a) is output to the user as a graphic interface.

5. The method for systematically collecting and searching for an access route of an information resource on Internet according to claim 3,
wherein, in the step (b), the information node file is stored in a search index folder selected by the user.

6. The method for systematically collecting and searching for an access route of an information resource on Internet according to claim 1,
wherein the hierarchical information node access route has a format in which at least one node name with a search event identifier as a prefix is connected in series.

7. The method for systematically collecting and searching for an access route of an information resource on Internet according to claim 1,
wherein, in the step (c), the process of outputting the node name list according to the input of the search identifier and the process of extending the information node access route according to the selection of a name of a node included in the list are repeated in a cycle until a target information node is output in the node name list.

8. The method for systematically collecting and searching for an access route of an information resource on Internet according to claim 7,
wherein, in the step (d), the settlement of an access route to the target information node is accomplished by means of a selection of the target information node output in the node name list.

9. The method for systematically collecting and searching for an access route of an information resource on Internet according to claim 1,
wherein, in the step (c), when the user inputs a text syllable by syllable in the state that the node name list is output, a node selection curser is automatically moved to a node name having the input text.

10. The method for systematically collecting and searching for an access route of an information resource on Internet according to claim 9,
wherein, in the step (c), when the user manipulates a predetermined node name selection key prepared on a keyboard in the state that the node selection curser is moved to a predetermined node name, the node name is added to the search event identifier so as to extend the information node access route by one step.

11. The method for systematically collecting and searching for an access route of an information resource on Internet according to claim 1,
wherein the hierarchical information node access route has a format in which names of search index nodes, each having a search event identifier as a prefix, are connected repeatedly.

12. The method for systematically collecting and searching for an access route of an information resource on Internet according to claim 1,
wherein, in the step (d), the process of outputting the target Internet information resource is any of outputting a web page through the web browser, regenerating a moving picture media by means of a moving picture regenerator whose execution route is registered in the web browser, regenerating a music by means of a music regenerator whose execution route is registered in the web browser, and outputting a corresponding file by means of an application program whose execution route is registered in an operation system.

13. The method for systematically collecting and searching for an access route of an information resource on Internet according to claim 1,
wherein, in the step a brief description about the Internet information resource is further input from the user as the basic search information to configure the information node.

14. The method for systematically collecting and searching for an access route of an information resource on Internet according to claim 1,
wherein the storage medium is a relational database, and wherein the search index node and the information node are respectively implemented as records in a node structure table provided in the relational database.

15. The method for systematically collecting and searching for an access route of an information resource on Internet according to claim 14,
wherein the node structure table includes fields for recording a record-specific identification code;
a node a node identification code for distinguishing a search index node and an information an identification code of a hierarchy to which a node belongs in the hierarchical tree structure;
a reference code for a parent node of each node in the hierarchical tree structure; and
an access route to an Internet information resource.

16. The method for systematically collecting and searching for an access route of an information resource on Internet according to claim 15, wherein the step (a) includes:
(a1) receiving a selection of a name and a parent search index node of a search index node to be formed from the user; and
(a2) forming a search index node in a database as a record form by recording a record-specific identification code; a node name; a node identification code designated as a search index node; and a reference node of the selected parent search index node, in corresponding fields of the node structure table.

17. The method for systematically collecting and searching for an access route of an information resource on Internet according to claim 16,
wherein the records corresponding to the search index node includes a record-specific identification code; a node name; a node identification code ; and a parent node reference code.

18. The method for systematically collecting and searching for an access route of an information resource on Internet according to claim 16,
wherein the node structure table further includes a field for recording a brief description of each node, wherein the step (a1) further receives a brief description of the search index node, and wherein the step (a2) further records the brief description in the corresponding field.

19. The method for systematically collecting and searching for an access route of an information resource on Internet according to claim 15, wherein the step (b) includes:
(b1) receiving the basic search information including an access route and a name of an Internet information resource loaded by the user using the web browser and a selection of a search index node to which the basic search information is linked in a parent-child relation, from the user; and
(b2) forming a record-type information node in a database by recording a record-specific identification code; a node name; a node identification code designated as an information node; a reference node of the selected parent search index node; and an access route to the Internet information resource, in corresponding fields of the node structure table.

20. The method for systematically collecting and searching for an access route of an information resource on Internet according to claim 19, wherein the record corresponding to the information node includes a record-specific identification code; a node name; a node identification node; a parent node reference code; and an Internet information resource access route.

21. The method for systematically collecting and searching for an access route of an information resource on Internet according to claim 19,
wherein the node structure table further includes a field for recording a brief description of each node, wherein the step (b1) further receives a brief description of the information node; and wherein the step (b2) further records the brief description in the corresponding field.

22. The method for systematically collecting and searching for an access route of an information resource on Internet according to claim 15,
wherein, in the step (c), the name list is made by reading records of a search index node and/or an information node linked as a child to the search index node belonging to the hierarchy according to the input order of the identifier input by the user and corresponding to a node name extended just before, extracting a node name from the read record, and outputting the node name in a list.

23. The method for systematically collecting and searching for an access route of an information resource on Internet according to claim 22, wherein, in the step (d), the access route to the Internet information resource is extracted from the read record.

24. A method for sharing an access route to an information resource on Internet with another person through a web server by a program installed on a computer in linkage with the web server, the method comprising:
(a) forming a search index node in a hierarchical tree structure in a storage medium of the computer according to a request of a user with a designated name;
(b) receiving basic search information including an access route and a name of an Internet information resource loaded by the user using a web browser, and a selection of a search index node to be linked on the basis the basic search information from the user, configuring an information with the basic search information, and then storing the information node in linkage with the search index node selected by the user;
(c) uploading a node structure including a search index node and an information node, constructed in a hierarchical tree structure, into a dedicated storage area distinguishable by means of a user ID of the web server according to an upload request of the user;
(d) requesting and receiving a user ID list possessing the node structure uploaded in the web server to/from the web server according to a request of a user, outputting the user ID list to the user, and receiving a selection of the user about a predetermined ID included in the ID list so that a node structure that is a search target of the information node is specified;
(e) providing a text search window to the user, and receiving a server-side hierarchical information node access route distinguished by a search event identifier through the search window, wherein, when there is an input of an identifier, the step (e) requests the web server with a name list of a child search index node and/or information node linked to a parent search index node prior to the input of the identifier and then stands by, and wherein, when the web server generates and transmits the requested name list in the node structure specified in the step (d), the step (e) transmits the name list to the user, then receives a selection of the user about a predetermined node name included in the name list, and adds the selected node name to the identifier so that a server-side access route of the information node is hierarchically extended step by step; and
(f) when an access route to a target information node is settled, extracting an access route of an Internet information resource from the corresponding information node, obtaining a target Internet information resource through Internet with the use of the extracted access route, and then outputting the target Internet information resource to the user.

25. The method for sharing an access route to an information resource on Internet with another person according to claim 24, wherein, in the step (a), the search index node is composed of a folder having a name designated by the user.

26. The method for sharing an access route to an information resource on Internet with another person according to claim 25, wherein, in the step (b), the information node is a file capable of extracting information about a name and URL of the information resource on Internet.

27. The method for sharing an access route to an information resource on Internet with another person according to claim 26, wherein, in the step (b), the information node file is stored in a search index folder selected by the user.

28. The method for sharing an access route to an information resource on Internet with another person according to claim wherein the hierarchical information node access route has a format in which at least one node name having a search event identifier as a prefix is connected in series.

29. A method for sharing an access route to an information resource on Internet with another person through a web server by a program installed on a computer in linkage with the web server, the method comprising:
(a) forming a search index node in a hierarchical tree structure in a storage medium of the computer according to a request of a user with a name of the search index node being designated;
(b) receiving basic search information including an access route and a name of an Internet information resource loaded by the user using a web browser, and a selection of a search index node to be linked on the basis the basic search information from the user, configuring an information with the basic search information, and then storing the information node in linkage with the search index node selected by the user;
(c) reading a node structure including a search index node and an information node recorded in the node structure table according to an upload request of the user, and uploading the node structure including into a database in linkage with the web server by means of identification of a user ID;
(d) requesting and receiving a user ID list possessing the node structure uploaded in the web server to/from the web server according to a request of a user, outputting the user ID list to the user, and receiving a selection of the user about a predetermined ID included in the ID list so that a node structure that is a search target of the information node is specified;
(e) providing a text search window to the user, and receiving a server-side hierarchical information node access route distinguished by a search event identifier through the search window, wherein, when there is an input of an identifier, the step (e) requests the web server with a child search index node and/or an information node linked to a parent search index node prior to the input of the identifier and then stands by, and wherein, when the web server reads and transmits records of a requested node in the node structure specified in the step (d), the step (e) extracts a name list of the node from the transmitted records, outputs the name list to the user, receives a selection of the user about a predetermined node name included in the name list, and adds the selected node name to the identifier so that a server-side access route of the information node is hierarchically extended step by step; and
(f) when an access route to a target information node is settled, extracting an access route of an Internet information resource included in the corresponding information node with reference to information of the transmitted records, obtaining a target Internet information resource through Internet with the use of the extracted access route, and then outputting the target Internet information resource to the user.

30. The method for sharing an access route to an information resource on Internet with another person according to claim 29,
wherein the search index node is composed of a record of the node structure table, and
wherein the step (a) records a record-specific identification code; a node name; a node identification code designating that the node is a search index node; and a parent node reference code, in a record corresponding to the search index node.

31. The method for sharing an access route to an information resource on Internet with another person according to claim 30,
wherein, in the step (a), a brief description of the search index node is further received from the user, and
wherein the brief description of the node is further recorded in a record corresponding to the search index node.

32. The method for sharing an access route to an information resource on Internet with another person according to claim 29,
wherein the information node is composed of a record of the node structure table, and
wherein the step (b) records a record-specific identification code; a node name; a node identification code designating that the node is an information node; and a parent node reference code, in a record corresponding to the information node.

33. The method for sharing an access route to an information resource on Internet with another person according to claim 32,
wherein, in the step (b), a brief description of the information node is further received from the user, and
wherein the brief description of the node is further recorded in a record corresponding to the information node.

34. The method for sharing an access route to an information resource on Internet with another person according to claim 29,
wherein, in the step (c), the node structure includes information about each record for the search index node and the information node, and
wherein a user ID is endowed to each record and then the record is recorded in a server-side node structure table provided in a database in linkage with the web server.

35. A method for accessing an Internet information resource with reference to a node structure on Internet, which is formed by means of a web server by repeatedly and accumulatively executing the following processes: composing a search index node in a mass storage medium in a hierarchical category structure, composing an information node for various Internet information resources so that the information node includes a name and an access route of each Internet information resource, and then linking the information node to a lower hierarchy of a predetermined search index node, the method comprising:
(a) providing a text search window to a user by means of a web browsing program installed on a computer of the user, and receiving a server-side hierarchical information node access route distinguishable by a search event identifier through the search window by means of the program, wherein, when there is an input of the identifier, the step (a) requests the web server with a name list of a child search index node and/or an information node linked to a parent search index node prior to the input of the identifier and then stands by, and wherein, when the web server generates and transmits the name list requested in the node structure, the step (a) outputs the name list to the user, receives a selection of the user about a predetermined node name included in the name list, and adds the selected node name to the identifier so that a server-side access route of the information node is hierarchically extended step by step; and
(b) when an access route to a target information node is settled, extracting an access route of an Internet information resource from the corresponding information node, obtaining a target Internet information resource through Internet with the use of the extracted access route, and then outputting the target Internet information resource to the user, by means of the program.

36-37. (canceled)
